(19) United States
(12) Patent Application Publication
(10) Pub. No.: US 2022/0245122 A1
(43) Pub. Date: Aug. 4, 2022

(54) DOCUMENT PACKAGE MODIFICATIONS BASED ON ORGANIZATION POLICIES IN A DOCUMENT MANAGEMENT PLATFORM

(71) Applicant: DocuSign, Inc., San Francisco, CA (US)

(72) Inventors: Andrew James Ashlock, San Francisco, CA (US); Marguerite Bouscaren, San Francisco, CA (US); Jacob Scott Mitchell, Richmond, VA (US); Saul Adams Aguilar, Redwood City, CA (US); Duane Robert Wald, Kent, WA (US); Christopher Shane Durham, Seattle, WA (US)

(21) Appl. No.: 17/162,744

(22) Filed: Jan. 29, 2021

(51) Int. Cl. G06F 16/23

(52) U.S. Cl. CPC G06F 16/2365

(57) ABSTRACT

A centralized document system generates a document package in response to a request by an originating entity. The document package includes at least one document for execution. To facilitate the execution of the at least one document, the centralized document system can provide one or more means to modify the document package. The centralized document system may provide the document package to a receiving entity and receive a request to modify the document package from the receiving entity. The centralized document system may scan the document package prior to sending to a receiving entity and automatically modify the document package according to the scan. The centralized document system may provide the document package to a receiving entity and determine the receiving entity is unavailable. As such, the centralized document system may determine a substitute receiving entity and provide the document package to the substitute entity for execution.

### BACKGROUND

This disclosure relates generally to the execution of documents, and more specifically to modifications of a document package during the execution of documents in a document management platform.

Once agreement is reached between two or more entities (such as companies, individuals, groups, or the like) regarding language, terms, or other contents of one or more documents, the entities may proceed to an execution phase for the one or more documents. During the execution phase, in current systems, one entity (e.g., an originating entity) generates a document package that includes the one or more documents and sends the document package to a second entity (e.g., a receiving entity). Sometimes, the originating entity may assign certain permissions and/or certain tasks associated with the document package to the receiving entity. However, certain policies (e.g., signing requirements) of an organization of the receiving entity may require one or more changes in permissions, contents, or actions associated with the document package before the document package can be executed. This can cause significant delays and unnecessary confusion in the execution phase as the receiving entity may need to re-assign the permissions and/or tasks to additional receiving entities to ensure compliance with the policies. Accordingly, manually ensuring compliance with document policies of an organization can result in an increase in the time and cost required for a document package to be executed.

### SUMMARY

The management of modifications to a document package during the execution of one or more documents within a document management platform is described herein. To facilitate the execution of the one or more documents between multiple entities (e.g., between an originating entity and a receiving entity), a centralized document system, in some embodiments, may provide a means for the receiving entity to re-assign certain permissions to another receiving entity (e.g., a second receiving entity). The permissions define one or more actions that an entity can perform in association with the one or more documents. To facilitate the execution of one or more documents between the originating entity and the receiving entity, the centralized document system, in some embodiments, may scan the document package to determine if any additional entities can perform one or more tasks so that policies corresponding to the receiving entity are complied with during the execution of the one or more documents.

In a first implementation, the centralized document system generates a document package in response to a request from an originating entity. The document package includes at least one document that corresponds to one or more document permissions assigned to the receiving entity by the originating entity. The one or more document permissions define one or more actions that the receiving entity can perform with regards to the document package. The centralized document system provides the document package to the receiving entity. The centralized document system receives a request from the receiving entity to assign a set of document permissions to a second receiving entity. In response to the set of document permissions being included within the one or more document permissions assigned to the receiving entity by the originating entity, the centralized document system automatically assigns the set of document permissions to the second receiving entity. In response to at least one of the set of document permissions not being included within the one or more document permissions assigned to the receiving entity by the originating entity, the centralized document system requests that the originating entity confirm that the second receiving entity be assigned the set of document permissions before assigning the set of document permissions to the second receiving entity.

In another implementation, the centralized document system generates a document package in response to a request from an originating entity. The document package includes at least one document for execution to be provided to an organization. The document package further identifies a first set of acting entities within the organization, and, for each acting entity of the first set of acting entities, identifies a first set of tasks that the acting entity is to perform with regards to the document package. The centralized document system accesses a policy of the organization that identifies, for each of one or more document types, a second set of acting entities corresponding to the document type. For each acting entity of the second set of acting entities, the policy identifies a second set of tasks that the acting entity is to perform before a document of the document type can be executed. The centralized document system scans the document package to determine whether the document package includes at least one document of the one or more document types identified by the policy. In response to the document package including at least one document of the one or more document types identified by the policy, the centralized document system automatically modifies the first set of acting entities to include one or more acting entities of the second set of acting entities corresponding to the at least one document type without requesting permission from the originating entity. The centralized document system provides the document package to the organization for execution.

In an additional implementation, the centralized document system generates a document package in response to a request from an originating entity. The document package includes at least one document for execution by a receiving entity of an organization. The centralized document system provides the document package to the receiving entity for execution. In response to receiving an indication that the receiving entity is unavailable to execute the at least one document of the document package, the centralized document system identifies a substitute entity based on one or more rules of the organization. The centralized document system modifies the document package based on the identified substitute entity. The centralized document system provides the modified document package to the substitute entity for execution.

### BRIEF DESCRIPTION OF THE DRAWINGS

FIG. 1 is a block diagram of a system environment in which a centralized document system operates, according to one embodiment.

FIG. 2 is a block diagram of a centralized document system, according to one embodiment.

FIG. 3 illustrates an example user interface displaying a document package, according to one embodiment.

FIG. 4 is a flowchart illustrating a first process for managing modifications to a document package using a centralized document system, according to one embodiment.

FIG. 5 is a flowchart for the first process of managing modifications to a document package using a centralized document system, according to one embodiment.

FIG. 6 is a flowchart illustrating a second process for managing modifications to a document package using a centralized document system, according to one embodiment.

FIG. 7 illustrates a data flow diagram for the second process of managing modifications to a document package using a centralized document system, according to one embodiment.

FIG. 8 is a flowchart illustrating a third process for managing modifications to a document package using a centralized document system, according to one embodiment.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### System Environment Overview

A system environment enables an originating entity of a first organization to create and send documents to one or more receiving entities of a second organization for negotiation, collaborative editing, electronic execution (e.g., electronic signature), automation of contract fulfilment, archival, and analysis, among other tasks. Within the system environment, a receiving entity may review content and/or terms presented in a digital document, and in response to agreeing to the content and/or terms, can electronically execute the document. In some embodiments, in advance of the execution of the documents, the originating entity may generate a document package to provide to the one or more receiving entities. The document package includes at least one document to be executed by one or more receiving entities. In some embodiments, the document package may also include one or more permissions defining actions the one or more receiving entities can perform in association with the document package. In some embodiments, the document package may also identify tasks the one or more receiving entities are to perform in association with the document package.

The system environment described herein can be implemented within a centralized document system, an online document system, a document management system, or any type of digital management platform. It should be noted that although description may be limited in certain contexts to a particular environment, this is for the purposes of simplicity only, and in practice the principles described herein can apply more broadly to the context of any digital management platform. Examples can include but are not limited to online signature systems, online document creation and management systems, collaborative document and workspace systems, online workflow management systems, multi-party communication and interaction platforms, social networking systems, marketplace and financial transaction management systems, or any suitable digital transaction management platform. It should also be noted that “centralized document system”, “document management system”, and other similar terminology are used interchangeably herein.

The processes described herein, in some implementations, provide a means for the one or more receiving entities to assign a set of permissions to additional receiving entities. The centralized document system automatically assigns the set of permissions to the additional receiving entities if the set of permissions are included in the one or more permissions originally assigned to receiving entities within the document package by the originating entity. The centralized document system requests that the originating entity confirm that the additional receiving entities can be assigned the set of permissions before assigning if the set of permissions are not included in the one or more permissions originally assigned to the receiving entities by the originating entity.

The processes described herein, in alternative implementations, provide a means for the document package to be modified prior to the document package being provided to the one or more receiving entities. The centralized document system scans the document package to determine whether the document package includes at least one document of a particular document type (e.g., purchase agreement, sales contract, etc.) specified in a policy of a second organization (the organization associated with the one or more receiving entities). The policy may specify for particular document types certain acting entities within the second organization and certain tasks the acting entities are to perform in relation to the document package before the documents can be executed. If the document package contains at least one document of a particular document type specified by the policy, the centralized document system automatically modifies the document package to identify the certain acting entities and the tasks the acting entities are to perform corresponding to the document type without requesting permission from the originating entity. The document package is then provided to the second organization for execution. It should also be noted that “acting entity”, “receiving entity”, and other similar terminology are used interchangeably herein.

The processes described herein, in additional implementations, provide a means for the document package to be modified to be sent an additional receiving entity if a receiving entity is unavailable. The centralized document system receives an indication that a receiving entity is unavailable and a substitute receiving entity is identified based on one or more rules of the second organization. The document package is modified and provided to the substitute entity for execution.

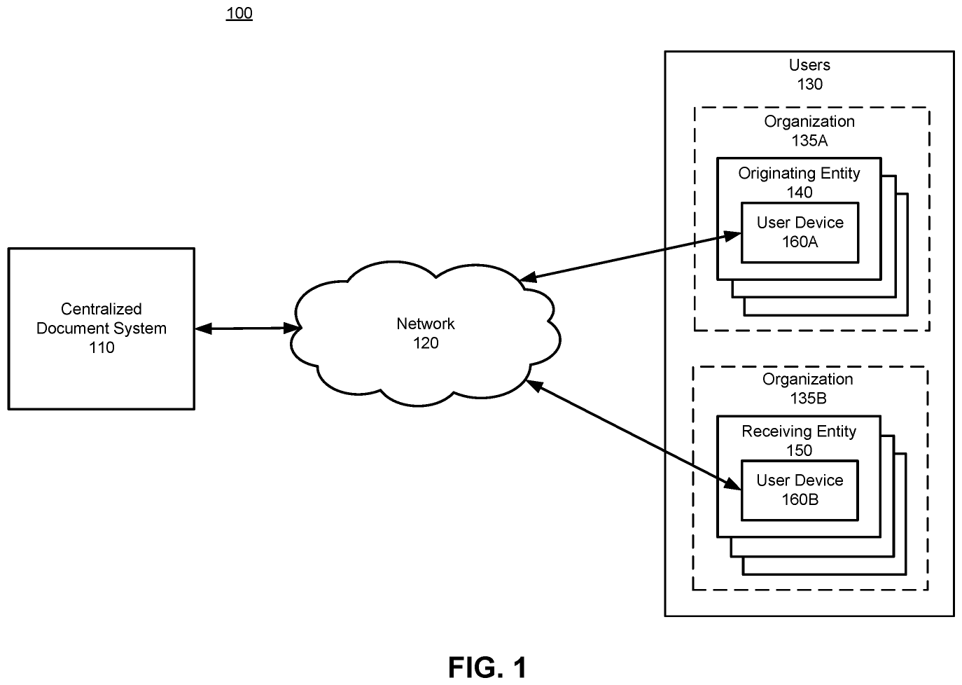

FIG. 1 is a block diagram of a system environment in which a centralized document system operates, according to one embodiment. The system environment 100 shown by FIG. 1 comprises a centralized document system 110, a network 120, a plurality of users 130 which includes a subset of originating entities 140 associated with a first organization 135A and a subset of receiving entities 150 associated with a second organization 135B, each associated with a user device 160 (e.g., originating entity 140 is associated with user device 160A and receiving entity 150 is associated with user device 160B). In alternative configurations, different and/or additional components may be included in the system environment 100.

The centralized document system 110 is a computer system (or group of computer systems) for storing and managing documents and/or document packages (e.g., envelopes) for a plurality of users 130. Using the centralized document system 110, users 130 can collaborate to create, edit, review, negotiate, and execute documents. During execution of one or more documents, the centralized document system 110 provides a means for generating and modifying a document package (also referred to as a document envelope). The document package may include at least one document for execution. The centralized document system 110 may provide the at least one document (e.g., a contract, agreement, purchase order, or other suitable document) in which terms have been agreed upon by two or more organizations (e.g., by two or more users 130, such as organization 135A and organization 135B) to a receiving entity 150 of organization 135B for execution, as described above. The centralized document system 110 may generate the document package per a request from an originating entity 140 of organization 135A. In some implementations, the document package may additionally include a set of document permissions. The centralized document system 110 may provide a means for the receiving entity 150 of organization 135B to request to assign the set of document permissions to a second receiving entity of organization 135B. In other implementation, the centralized document system 110 may scan the document package (including the document) to determine whether the document package includes a document of a particular type (e.g., identified by a policy of organization 135B), and if so, may provide the document package to additional receiving entities 150 of organization 135B not originally specified to receive the document package. In other implementations, the centralized document system 110 modifies the document package to be sent to a substitute receiving entity 150 based on the original receiving entity 150 being unavailable.

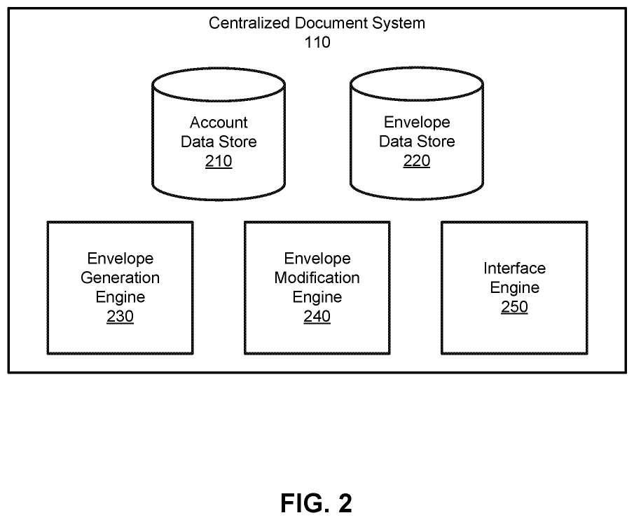

The centralized document system 110 can be a server, server group or cluster (including remote servers), or another suitable computing device or system of devices. In some implementations, the centralized document system 110 can communicate with user devices 160 over the network 120 to receive instructions and send document packages (or other information) for viewing on user devices 160. The centralized document system 110 will be discussed in further detail with respect to FIG. 2.

The network 120 transmits data within the system environment 100. The network 120 may comprise any combination of local area and/or wide area networks, using both wired and/or wireless communication systems, such as the Internet. In some embodiments, the network 120 transmits data over a single connection (e.g., a data component of a cellular signal, or Wi-Fi, among others), and/or over multiple connections. In some embodiments, the network 120 uses standard communications technologies and/or protocols. For example, the network 120 includes communication links using technologies such as Ethernet, 802.11, 3G, 4G, code division multiple access (CDMA), digital subscriber line (DSL), and the like. Data exchanged over the network 120 may be represented using any suitable format, such as hypertext markup language (HTML) or extensible markup language (XML). In some embodiments, the network 120 may include encryption capabilities to ensure the security of customer data. For example, encryption technologies may include secure sockets layers (SSL), transport layer security (TLS), virtual private networks (VPNs), and Internet Protocol security (IPsec), among others.

Through the network 120, the centralized document system 110 can communicate with user devices 160 associated with the users 130. A user 130 can represent an individual, group, or other entity that is able to interact with document packages (or other content) generated on and/or managed by the centralized document system 110. Each user 130 can be associated with a username, email address, or other identifier that can be used by the centralized document system 110 to identify the user 130 and to control the ability of the user 130 to view, modify, and otherwise interact with document packages managed by the centralized document system 110. In some implementations, users 130 can interact with the centralized document system 110 through a user account with the centralized document system 110 and one or more user devices 160 accessible to that user 130. In the embodiment of FIG. 1, the plurality of users 130 are split into users associated with organization 135A and users associated with the organization 135B.

As described above, an organization 135 is a business, group, individual, or the like that is associated with a set of users 130 and one or more document packages in the centralized document system 110. For example, a document package may originate at organization 135A and be sent to organization 135B for viewing, editing, and execution. In a specific implementation, the document package may be created by originating entity 140 and be sent via the centralized document system 110 to a receiving entity 150 during the execution of the one or more documents included within the document package.

In the embodiment of FIG. 1, an originating entity 140 from the organization 135A creates the document package via the centralized document system 110. In this example, the organization 135A includes a set of originating entities 140 which, as used herein, are users 130 who have a user account with the centralized document system 110. The organization 135B includes a set of receiving entities 150 which, as used herein, are users 130 who have a user account with the centralized document system 110. The document package is sent by the centralized document system 110 for review and execution by a receiving entity 150 of the organization 135B.

Each user device 160 is a computing device capable of receiving user input (for example from a user 130) as well as transmitting and/or receiving data to the centralized document system 110 via the network 120. For example, a user device 160 can be a desktop or a laptop computer, a smartphone, tablet, or another suitable device. User devices 160 are configured to communicate via the network 120 (for example, with the centralized document system 110). In one embodiment, a user device 160 executes an application allowing a user 130 of the user device 160 to interact with the centralized document system 110. For example, a user device 160 can execute a browser application to enable interaction between the user device 160 and the centralized document system 110 via the network 120. In some embodiments, a single user 130 can be associated with multiple user devices 160, and/or one user device 160 can be shared between multiple users 130 who may, for example, log into a personal account on the user device 160 to access the centralized document system 110.

### Example Centralized Document System Architecture

FIG. 2 is a block diagram of a centralized document system 110, according to one embodiment. Components of the centralized document system 110 may be a combination of hardware and software. The centralized document system 110 may include an account data store 210, an envelope data store 220, an envelope generation engine 230, an envelope modification engine 240, and an interface engine 250. In various embodiments, the centralized document system 110 may include fewer or additional components that are not shown in FIG. 2. For example, conventional components such as network interfaces, security functions, load balancers, failover servers, management and network operations consoles, and the like are not shown so as to not obscure the details of the system architecture. The functions of the centralized document system 110 may be distributed among the components in a different manner than described.

The account data store 210 is a file storage system, database, set of databases, or other data storage system storing information associated with accounts of the centralized document system 110. Organizations 135 may be associated with one or more accounts with the centralized document system 110. In some embodiments, an organization 135 may be associated with a parent account and each entity within the organization 135 may be associated with a user account. For example, organization 135B has a parent account and each receiving entity 150 within organization 135B has a user account with the centralized document system 110. The parent account may be associated with a policy of the organization 135 and/or an org chart for the organization 135. A policy of the organization 135 is a system of principles that guide certain processes or workflows for the organization 135. For example, a policy of organization 135B may dictate which receiving entities 150 within the organization 135B are to receive document packages and a set of tasks the receiving entities 150 are to perform in relation to the document package or a set of permissions the receiving entities 150 may be subject to in relation to the document package. In some embodiments, the policy specifies acting entities and corresponding sets of tasks for the acting entities to perform in relation to the document package based on document types and/or types of document content of the one or more documents included in the document package. In some embodiments, the policy specifies one or more thresholds corresponding to one or more types of document content (e.g., a payment amount, a payment term, etc.). For example, a policy may specify a threshold payment amount and corresponding acting entities and sets of tasks for the acting entities to perform if a payment amount within a document package exceeds the threshold payment amount. The org chart may include a list of entities (e.g., including names, titles, roles, departments, direct reports, supervisors, teams, groups, etc.) within the organization 135.

Each user account associated with an entity may include information about the entity, such as information about the individual with access to the user account, age of the account, frequency of account use, log of past account transactions, and the like. Information about the individual with access to the account may include the individual's name, email address, title, role, department, and the like. The individual's title is a position title or job title held by the individual with the organization 135. The individual's role is a function that the individual fulfills within their organization 135. For example, a title may be “General Counsel” and a role may be reviewing and executing agreements. The individual's department is a group within the organization 135 where the individual works. For example, a department may be operations, finance, sales, human resources, purchases, legal, and the like.

The envelope data store 220 is a file storage system, database, set of databases, or other data storage system storing information associated with document envelopes. Organizations 135 provide one or more documents for execution to other organizations 135 via envelopes. A document envelope (also referred to as a document package) can include at least one document for execution. The at least one document may have been previously negotiated by the organizations 135A and 135B. And, as such, the document may be ready for execution upon the creation of an envelope. The document package may also include recipient information and document fields indicating which fields of the document need to be completed for execution (e.g., where a receiving entity 150 should sign, date, or initial the document). The recipient information may include contact information for a receiving entity 150 (e.g., a name and email address).

In some embodiments, the document package may also include a set of permissions. The set of permissions may be assigned by an originating entity 140. The set of permissions included in the document package define one or more actions that a receiving entity 150 can perform with regard to the document package. The one or more actions may include adding one or more additional receiving entities 150 to the document package, removing one or more receiving entities 150 from the document package, updating an order in which two or more receiving entities 150 receive the document package, updating one or more tasks of one or more receiving entities 150 of the document package, adding one or more additional documents to the document package, removing one or more documents from the document package, providing a notification (e.g., “Documents within document package need careful review”) to one or more receiving entities 150 about the document package, and the like. For example, an originating entity 140 may set the following permissions for a document package: allow receiving entity 150 to add additional receiving entities 150, allow receiving entity 150 to remove one or more documents from the document package, allow receiving entity 150 to execute one or more documents, allow receiving entity 150 to modify one or more documents, and the like.

In some embodiments, the document package may also identify a first set of acting entities (e.g., the receiving entities 150 of organization 135B specified by the originating entity 140 that are to be provided with the document package), and for each acting entity, the document package may also identify a first set of tasks that the acting entity is to perform with regard to the document package. The first set of tasks may define what each acting entity is to do and complete before the at least one document of the document package can be executed. The set of tasks may include reviewing the at least one document, initialing the at least one document, signing the at least one document, providing information for the at least one document, and the like.

The envelope generation engine 230 may generate envelopes for a user 130 to send to a different user 130. For example, the envelope generation engine 230 may generate an envelope for organization 135A to send to organization 135B. In a specific implementation, the envelope generation engine 230 may receive instructions from the originating entity 140 of organization 135A to generate an envelope (also referred to as a document package) that will be sent to one or more receiving entities 150 of organization 135B. The envelope generation engine 230 may generate a document package that includes at least one document for execution. In an implementation, the envelope generation engine 230 may generate a document package that may also include a set of permissions corresponding to each document of the document package. In another implementation, the envelope generation engine 230 may generate a document package that identifies a first set of acting entities and for each acting entity a first set of tasks that each acting entity of the first set of acting entities is to perform with regards to the document package (for instance before the documents of the document package can be executed).

In some embodiments, the envelope generation engine 230 may provide the document package to one or more receiving entities 150 after the document package has been generated per a request from an originating entity 140. In alternative embodiments, the envelope generation engine 230 may provide the document package to one or more receiving entities 150 after the document package has been modified by the envelope modification engine 240.

The envelope modification engine 240 manages modifications made to a document package. In some embodiments, the modifications are requested by a user 130 (e.g., by a receiving entity 150) and provided to an originating entity for approval. In some embodiments, the modifications are automatically applied by the envelope modification engine 240 after requested by a user (such as the receiving entity 150).

In an implementation, where a document package has been provided to one or more receiving entities 150, the envelope modification engine 240 may receive a request from a first receiving entity 150 to assign a set of document permissions to a second receiving entity. For example, the first receiving entity 150 (such as an employee) may review the document package via a user interface of a user device 160B associated with the first receiving entity 150 and may request to assign a set of document permissions to the second receiving entity (such as a manager of the employee) via the user interface. The envelope modification engine 240 may receive the request and determine if the set of document permissions are included within the one or more document permissions of the document package (e.g., within the one or more document permissions assigned by the originating entity 140). In an embodiment, where the envelope modification engine 240 determines the set of document permissions requested by the receiving entity 150 is included in the permissions assigned by the originating entity 140, the envelope modification engine 240 may automatically assign the set of document permissions to the second receiving entity. In an embodiment, where the envelope modification engine 240 determines the set of document permissions is not included in the permissions assigned by the originating entity 140, the envelope modification engine 240 may request that the originating entity 140 confirm that the second receiving entity can be assigned the set of document permissions before assigning the set of document permissions to the second receiving entity.

In an example embodiment, the document package includes at least one document and one or more document permissions assigned by the originating entity 140. In this embodiment, the document permissions include allowing a receiving entity to perform the following actions with regard to the document package: add one or more additional receiving entities 150 to the document package and update an order in which two or more receiving entities 150 may receive the document package. The receiving entity 150 is provided the document package via the envelope generation engine 230.

Continuing with this example embodiment, in a first scenario, the receiving entity 150 requests that a second receiving entity be able to update an order in which two or more receiving entities 150 may receive the document package. In a second scenario, the receiving entity 150 requests that a second receiving entity be able to add one or more additional documents to the document package. In the first scenario, the envelope modification engine 240 receives the request and automatically assigns to the second receiving entity a permission to update an order in which two or more receiving entities 150 may receive the document package as this permission was included in the one or more document permissions assigned by the originating entity 140. In the second scenario, the envelope modification engine 240 receives the request and requests that the originating entity 140 confirm that the second receiving entity can be assigned a permission to add one or more additional documents to the document package as this permission was not included in the one or more document permissions assigned by the originating entity 140.

In embodiments where the envelope modification engine 240 requests that the originating entity 140 confirm the assignment of document permissions to a second receiving entity, the envelope modification engine 240 may receive a confirmation from the originating entity 140 and may, in response, assign the document permissions to the second receiving entity. In some embodiments, the envelope modification engine 240 may then provide the document package with the set of approved document permissions to the second receiving entity. In alternative embodiments, the envelope modification engine 240 may receive an indication from the originating entity 140 that the second receiving entity cannot be assigned the document permissions. The envelope modification engine 240 may provide a notification to the receiving entity 150 that the second receiving entity cannot be assigned the document permissions.

In another implementation, the envelope modification engine 240 may automatically apply modifications to the document package. In an embodiment, the document package generated by the envelope generation engine 230 includes at least one document to be executed and identifies a first set of acting entities (e.g., one or more receiving entities 150 of organization 135B), and for each acting entity, the document package also identifies a first set of tasks that the acting entity is to perform with regard to the document package. For example, the document package may specify two acting entities in the first set of acting entities with one entity to perform a review of the at least one document in the document package and a second entity to sign the at least one document.

The envelope modification engine 240 may access a policy of the organization 135B stored in the account data store 210. As described above, a policy of an organization 135 may specify which entities within the organization 135 are to receive document packages and a set of tasks the entities may perform in relation to the document package. In order to determine if the document package should be modified to be sent to additional entities within organization 135B, the envelope modification engine 240 scans the document package. During the scan, the envelope modification engine 240 scans the document(s) and the first set of acting entities defined by the originating entity 140 during generation of the document package. In some embodiments, the envelope modification engine 240 may scan the at least one document to determine whether the at least one document is of one or more document types identified in the policy of the organization 135B and may scan the first set of acting entities to determine whether the set includes the entities identified in the policy per document type. The document types are categories of documents and may include a purchase agreement, a confidentiality agreement, a rental agreement, an employee agreement, a sales contract, a bank form, and the like. In response to the document package including a document of the one or more document types identified by the policy and the first set of acting entities not including one or more entities defined by the policy for the document type, the envelope modification engine 240 may automatically modify the first set of acting entities to include one or more additional entities (e.g., a second set of acting entities) based on the policy. The envelope modification engine 240 may perform this modification without requesting permission or confirmation from the originating entity 140.

In an example scenario, the generated document package may include a purchase agreement and a first set of acting entities that includes one receiving entity 150 at organization 135B who is to perform a set of tasks including to review and sign the purchase agreement. The envelope modification engine 240 accesses a policy of organization 135B associated with receiving entity 150. The policy identifies sets of acting entities corresponding to a purchase agreement (a document type). Each set of acting entities identified in the policy also correspond to sets of tasks that each acting entity is to perform before the at least one document can be executed. The envelope modification engine 240 scans the document package and determines the document to be a purchase agreement and the first set of acting entities to not include two acting entities identified in the policy corresponding to a purchase agreement. As such, the envelope modification engine 240 automatically modifies the first set of acting entities to include the two acting entities. The modified document package may be provided to the first set of acting entities and the two acting entities (e.g., a second set of acting entities) where the first set of acting entities can review and sign the purchase agreement and the second set of acting entities can perform the set of tasks identified in the policy (e.g., initial the purchase agreement).

In some embodiments, the envelope modification engine 240 may scan the document(s) of the document package to determine whether the document(s) includes one or more types of document content identified by the policy. The envelope modification engine 240 may scan a document by identifying text of the at least one document (e.g., using object recognition techniques) and performing natural language processing on the identified text (e.g., using a heuristic solution, a machine-learned model, etc.) to identify the one or more types of document contents. A type of document content is words, phrases, clauses, or other content and may include a payment amount, a payment term, a late payment penalty, a limited liability clause, a product or service, and the like. In response to the document package including at least one type of document content identified by the policy, the envelope modification engine 240 may automatically modify the first set of acting entities to include one or more additional entities (e.g., a third set of acting entities) based on the policy.

In an example scenario, the generated document package may include a sales contract and a first set of acting entities that includes one receiving entity 150 at organization 135B who is to perform a set of tasks including reviewing and signing the sales contract. The envelope modification engine 240 accesses a policy of organization 135B and identifies a set of acting entities (e.g., a second set of acting entities) corresponding to a sales contract (a document type) and a set of acting entities (e.g., a third set of acting entities) corresponding to a payment amount (a type of document content) and a payment term (another type of document content). Each set of acting entities identified in the policy also corresponds to sets of tasks that each acting entity is to perform before the at least one document can be executed. The envelope modification engine 240 scans the document package and determines the document to be a sales contract and to include a payment term identified by the policy. Based on the scan, the envelope modification engine 240 determines the first set of acting entities does not include one acting entity of the second set and one acting entity of the third set. In response, the envelope modification engine 240 automatically modifies the first set of acting entities to include the two acting entities. The modified document package may be provided to the first set of acting entities and the two acting entities where the first set of acting entities can review and sign the sales contract and the two acting entities (one from the second set and one from the third set) can perform the set of tasks identified in the policy (e.g., initialing the purchase agreement).

In some embodiments, where a document includes a payment amount as a type of document content, the envelope modification engine 240 compares the payment amount to a threshold payment amount included in the policy. In response to the payment amount being greater than the threshold payment amount, the envelope modification engine 240 may automatically modify the first set of acting entities to include one or more additional entities based on the policy. For example, the policy of organization 135B specifies a threshold payment amount of $500,000, a set of acting entities at organization 135B corresponding to the threshold payment amount, and a set of tasks for the acting entities to perform. The envelope modification engine 240 identifies a payment amount of $1 million in a document of a document package to be sent to organization 135B and compares the payment amount to the threshold payment amount. Based on the comparison, the envelope modification engine 240 automatically modifies a first set of acting entities to include the set of acting entities specified in the policy corresponding to the threshold payment amount.

In some embodiments, where a document includes a payment term as a type of document content, the envelope modification engine 240 compares the payment term to a threshold payment term included in the policy. In response to the payment term being greater than the threshold payment term, the envelope modification engine 240 may automatically modify the first set of acting entities to include one or more additional entities based on the policy. For example, the policy of organization 135B specifies a threshold payment term of 30 days, a set of acting entities at organization 135B corresponding to the threshold payment term, and a set of tasks for the acting entities to perform. The envelope modification engine 240 identifies a payment term of 60 days in a document of a document package to be sent to organization 135B and compares the payment term to the threshold payment term. Based on the comparison, the envelope modification engine 240 automatically modifies a first set of acting entities to include the set of acting entities specified in the policy corresponding to the threshold payment term.

In some implementations, where the document package has been provided to one or more receiving entities 150, the envelope modification engine 240 may receive an indication that a receiving entity 150 is unavailable to execute the at least one document of the document package. In some embodiments, the envelope modification engine 240 may receive an out of office message from an email account associated with the receiving entity 150. In some embodiments, the envelope modification engine 240 may receive a message from the organization 135B indicating that the receiving entity 150 is unavailable. In some embodiments, the envelope modification engine 240 may determine the receiving entity 150 is unavailable based on the receiving entity 150 not accessing the document package within a threshold amount of time (e.g., 12 hours, 24 hours, etc.).

In response to receiving the indication, the envelope modification engine 240 may identify a substitute receiving entity 150 within the organization 135B to provide the document package to. The envelope modification engine 240 may identify the substitute entity based on one or more rules of the organization 135B. The one or more rules specify how the envelope modification engine 240 is to identify a substitute entity to provide the document package to when a receiving entity 150 is unavailable. For example, one rule may specify that the envelope modification engine 240 identifies a substitute entity by querying the org chart of the organization 135B stored in the account data store 210 and identifying an entity within the org chart that satisfies one or more document package requirements as the substitute entity.

The one or more document package requirements are necessary conditions that a substitute entity should satisfy. The one or more document package requirements may include a threshold title, a threshold role, and/or a threshold department. In some embodiments, the threshold title, the threshold role, and the threshold department are dynamic and may be based on the title, role, and department of the receiving entity 150. In some embodiments, the threshold title, the threshold role, and the threshold department are set by the organization 135B of the receiving entity 150 regardless of the title, role, and department of the receiving entity 150. The envelope modification engine 240 may review the org chart and select an entity as a substitute entity when the entity's title, role, and/or department meets or exceeds the threshold title, role, and/or department. For example, a threshold title is ‘Level II Sales Manager,’ a threshold role is sales contracts review, and a threshold department is Sales and a substitute entity must have a title of at least a ‘Level II Sales Manager’ and must satisfy the threshold role and threshold department.

In another example, a second rule may specify that the envelope modification engine 240 identify a substitute entity that is a supervisor or manager of the organization 135B. The envelope modification engine 240 may determine this by querying the various user accounts of individuals within the organization 135B from the account data store 210 or by querying an org chart of the organization 135B, and/or by identifying entities with a title that includes ‘supervisor’ or ‘manager’.

In some embodiments, the envelope modification engine 240 may identify a substitute entity by receiving an identity of a candidate substitute entity from the organization 135B. The envelope modification engine 240 may provide the identity of the candidate substitute entity to the originating entity 140 for approval. Based on receiving approval from the originating entity 140, the envelope modification engine 240 may select the entity as the substitute entity.

Once a substitute entity is identified, the envelope modification engine 240 may modify the document package based on the identified substitute entity. In some embodiments, the envelope modification engine 240 may update the recipient information of the document package to include the substitute entity's contact information. In some embodiments, the envelope modification engine 240 may change information associated with the receiving entity 150 within a document included in the document package to corresponding information associated with the substitute entity. For example, the envelope modification engine 240 may update a signature field within the document to include the substitute entity's information (name, title, etc.).

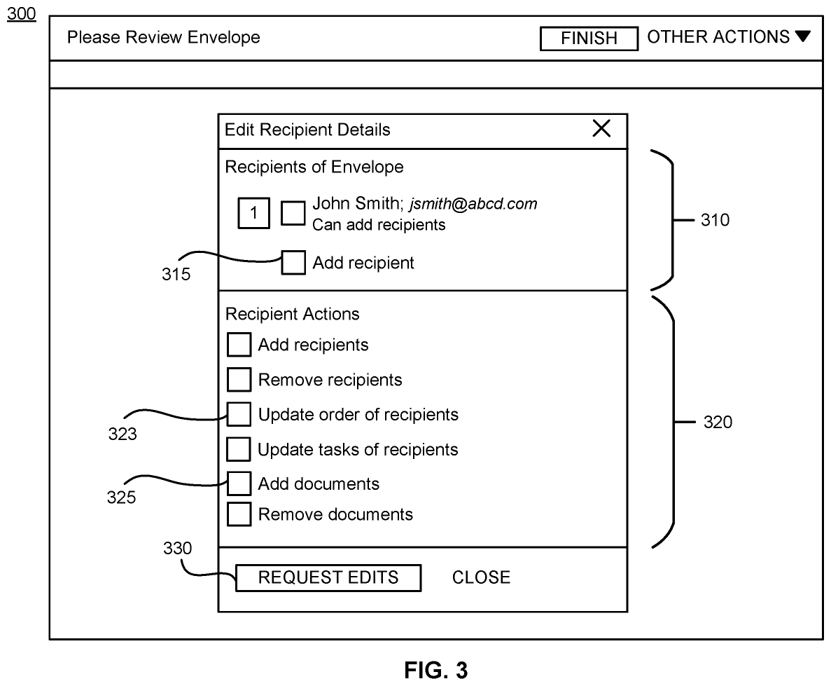

The interface engine 250 may generate user interfaces allowing users 130 to interact with document packages managed by the centralized document system 110. For example, the interface engine 250 may generate a user interface for an originating entity 140 to generate a document package. In another example, the interface engine 250 may generate a user interface for a receiving entity 150 to view a document package. In some implementations, the interface engine 250 may provide a user interface enabling a receiving entity 150 to modify a document package. For example, the interface engine 250 may display a listing of the one or more receiving entities 150 of the document package to a receiving entity 150 on an electronic display of a user device 160B. The interface engine 250 may provide one or more interface elements (e.g., links, buttons, checkboxes, etc.) on the electronic display for the receiving entity 150 to select in order to request to assign a set of document permissions to an additional receiving entity 150. In some implementations, the interface engine 250 may generate a user interface for displaying a notification to a receiving entity 150 that an additional receiving entity 150 cannot be assigned the set of document permissions. The interface engine 250 and an example user interface will be discussed further below in relation to FIG. 3.

### Example User Interface

FIG. 3 illustrates an example user interface 300 for editing recipients of a document package, according to one embodiment. FIG. 3 illustrates a user interface 300 from the perspective of a receiving entity 150. The user interface 300 includes a recipient editing portion 310 and a permission editing portion 320. In alternative configurations, different and/or additional user interface elements may be included in the user interface 300.

In the embodiment of FIG. 3, a document package (also referred to as an envelope) has been generated by a centralized document system 110 and provided to a receiving entity 150 (e.g., John Smith). The document package includes one or more document permissions assigned by an originating entity 140 to the receiving entity 150. As described above, the one or more document permissions define one or more actions the receiving entity 150 may perform in regard to the document package.

In the embodiment of FIG. 3, the recipient editing portion 310, according to some embodiments, allows the receiving entity 150 (e.g., John Smith) to add one or more additional recipients (e.g., add one or more additional receiving entities 150 to receive the document package) by selecting checkbox 315. In an example, by selecting the checkbox 315, the receiving entity 150 may add a second receiving entity to the document package. In some embodiments, to add the second receiving entity, the receiving entity 150 (John Smith) may be asked to type in the second receiving entity's name or email address into a text box displayed in the user interface 300. In some embodiments, to add the second receiving entity, the receiving entity 150 may select the second receiving entity from a dropdown menu displayed in the user interface 300.

In the embodiment of FIG. 3, the permission editing portion 320, according to some embodiments, allows the receiving entity 150 to request to assign a set of document permissions to the second receiving entity. For example, the receiving entity 150 may request to assign the following document permissions to the second receiving entity: a permission to update an order of the recipients of the document package and a permission to add documents to the document package. The receiving entity 150 may do so by selecting checkbox 323 and checkbox 325. After the receiving entity 150 is done selecting which document permissions to assign to the second receiving entity, the receiving entity 150 may select button 330 to submit the request to the centralized document system 110. The centralized document system 110 automatically assigns the set of document permissions to the second receiving entity if the set of document permissions was included in the one or more document permissions assigned to the receiving entity 150 by the originating entity 140. The centralized document system 110 requests that the originating entity 140 confirm that the second receiving entity can be assigned the set of document permissions if at least one of the set of document permissions is not included in the one or more document assigned to the receiving entity 150. If the originating entity 140 confirms the assignment, the centralized document system 110 provides the second receiving entity with the set of document permissions, and if not, a notification may be provided to the receiving entity 150 via the user interface 300 indicating the second receiving entity cannot be assigned the set of document permissions. In some embodiments, if the set of document permissions assigned by the receiving entity 150 to the second receiving entity includes some permissions that were assigned to the receiving entity 150 by the originating entity 140 and some that were not, the permissions in the set of document permissions that were assigned to the receiving entity 150 are automatically assigned to the second receiving entity, and the permissions that were not assigned to the receiving entity 150 by the originating entity 140 are provided to the originating entity for confirmation before being assigned to the second receiving entity.

### Document Package Modification Based on Assigned Permissions

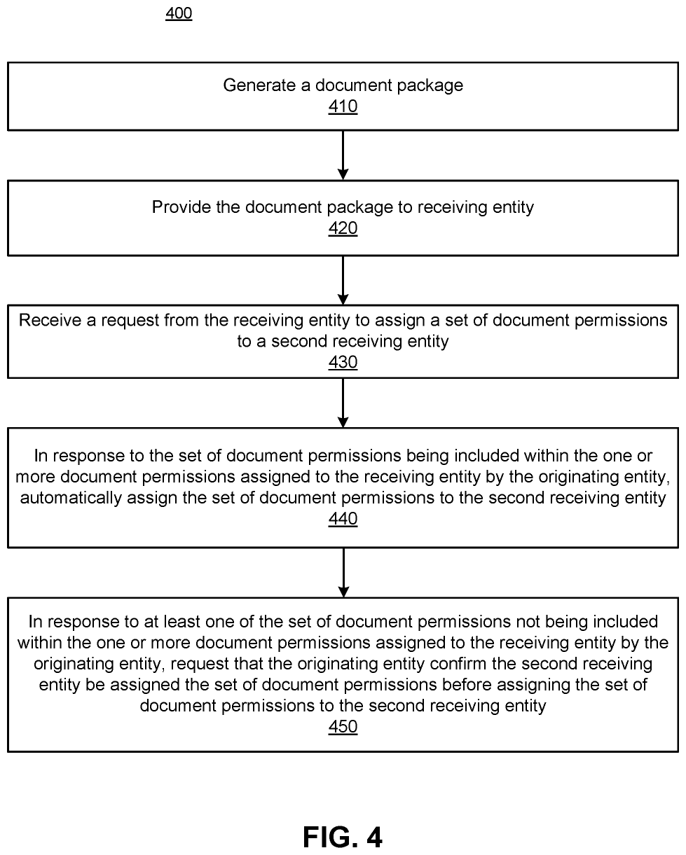

FIG. 4 is a flowchart illustrating a first process 400 for managing modifications to a document package using a centralized document system 110, according to one embodiment. It should be noted that in other embodiments, the first process 400 illustrated in FIG. 4 can include fewer, additional, or different steps that those described herein.

The centralized document system 110 generates 410 a document package. The centralized document system 110 may generate the document package in response to a request from an originating entity 140. The document package may include at least one document for execution and one or more document permissions assigned to a receiving entity 150 by the originating entity 140. The one or more document permissions define one or more actions that the receiving entity 150 can perform with regard to the document package.

The centralized document system 110 provides 420 the document package to the receiving entity 150. For example, the centralized document system 110 may display the document package in a user interface of a user device 160B associated with the receiving entity 150.

The centralized document system 110 receives 430 a request from the receiving entity 150 to assign a set of document permissions to a second receiving entity. For example, the receiving entity 150 may make the request from the user interface in which the document package is displayed.

In response to the set of document permissions being included within the one or more document permissions assigned to the receiving entity 150 by the originating entity 140, the centralized document system 110 automatically assigns 440 the set of document permissions to the second receiving entity. For example, the originating entity 140 assigned the following document permissions to the receiving entity 150: a permission to remove one or more receiving entities 150 from the document package and a permission to update a task of one or more receiving entities 150 of the document package. The receiving entity 150 requests to assign a permission to update a task of one or more receiving entities 150 of the document package to a second receiving entity. The requested set of document permissions is included in the assigned document permissions. As such, the centralized document system 110 automatically assigns the permission to update a task of one or more receiving entities 150 of the document package to the second receiving entity.

In response to the set of document permissions not being included within the one or more document permissions assigned to the receiving entity 150 by the originating entity 140, the centralized document system 110 requests 450 that the originating entity 140 confirm the second receiving entity be assigned the set of document permissions before assigning the set of document permissions to the second receiving entity. For example, the originating entity 140 assigned the following document permissions to the receiving entity 150: a permission to add one or more receiving entities 150 to the document package and a permission to add one or more documents to the document package. The receiving entity 150 requests to assign a permission to update a task of one or more receiving entities 150 of the document package to a second receiving entity. The requested set of document permissions is not included in the assigned document permissions. As such, the centralized document system 110 requests that the originating entity 140 confirm the requested set of document permissions before assigning the request set of document permissions to the second receiving entity.

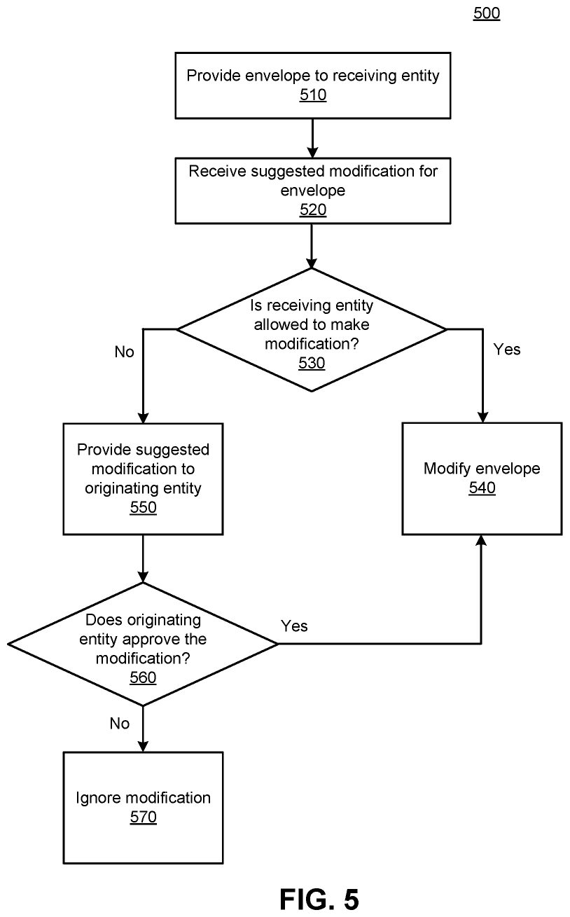

FIG. 5 is a flowchart 500 for the first process of managing modifications to a document package using a centralized document system 110, according to one embodiment. Embodiments may include different and/or additional steps, or performance of the steps in different orders.

The centralized document system 110 may provide 510 an envelope (also referred to as a document package) to a receiving entity 150. For example, the centralized document system 110 may display the envelope and its contents on a user interface of a user device 160B associated with the receiving entity 150. The centralized document system 110 may receive 520 a suggested modification for the envelope from the receiving entity 150. For example, the receiving entity 150 may request to assign a set of document permissions to a second receiving entity. The centralized document system 110 may determine 530 if the receiving entity 150 is allowed to make the modification. For example, the centralized document system 110 may compare the requested set of document permissions to one or more document permissions originally assigned to the receiving entity 150 by an originating entity 140. If the receiving entity's 150 suggested modification (e.g., request to assign the set of document permissions to the second receiving entity) is included in the one or more document permissions, the centralized document system 110 may modify 540 the envelope. If the receiving entity's 150 suggested modification (e.g., request to assign the set of document permissions to the second receiving entity) is not included in the one or more document permissions, the centralized document system 110 may provide 550 the suggested modification to the originating entity 140. The centralized document system 110 may determine 560 if the originating entity 140 approves the suggested modification. If the originating entity 140 approves the suggested modification, the centralized document system 110 may modify 540 the envelope (e.g., assign the set of document permissions to the second receiving entity). If the originating entity 140 does not approve, the centralized document system 110 may ignore 570 the suggested modification.

### Document Package Modification Based on Organization Policies

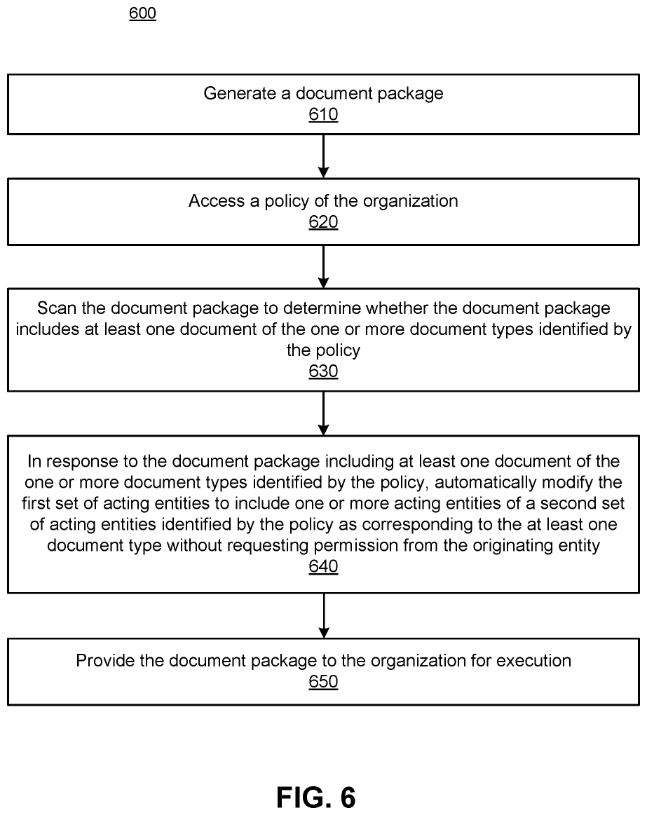

FIG. 6 is a flowchart illustrating a second process 600 for managing modifications to a document package using a centralized document system 110, according to one embodiment. It should be noted that in other embodiments, the second process 600 illustrated in FIG. 6 can include fewer, additional, or different steps that those described herein.

The centralized document system 110 generates 610 a document package. The centralized document system 110 may generate the document package in response to a request provided by an originating entity 140 of organization 135A. The document package may include at least one document for execution and may identity a first set of acting entities (e.g., one or more receiving entities 150) within organization 135B. For each acting entity of the first set of acting entities, the document package may also identify a first set of tasks that the acting entity is to perform with regards to the document package. Tasks may include reviewing the document(s) included in the document package, initialing the document(s) included in the document package, signing the document(s) included in the document package, and the like.

The centralized document system 110 accesses 620 a policy of the organization 135B. The policy may identify, for each of one or more document types, a second set of acting entities (e.g., one or more receiving entities 150) of organization 135B that correspond to the document type. For each acting entity of the second set of acting entities, the document package may also identify a second set of tasks that the acting entity is to perform before the at least one document can be executed.

The centralized document system 110 scans 630 the document package to determine whether the document package includes at least one document of the one or more document types identified by the policy. For example, the centralized document system 110 may scan the document(s) included in the document package to determine if any of the document(s) are of the document types identified in the policy of the organization 135B.

In response to the document package including at least one document of the one or more document types identified by the policy, the centralized document system 110 automatically modifies 640 the first set of acting entities to include one or more acting entities of the second set of acting entities corresponding to the at least one document type without requesting permission from the originating entity 140.

The centralized document system 110 provides 650 the document package to the organization 135B for execution. For example, the centralized document system 110 provides the document package that has been modified to identify acting entities of the first set and the second set to the acting entities of the organization 135B.

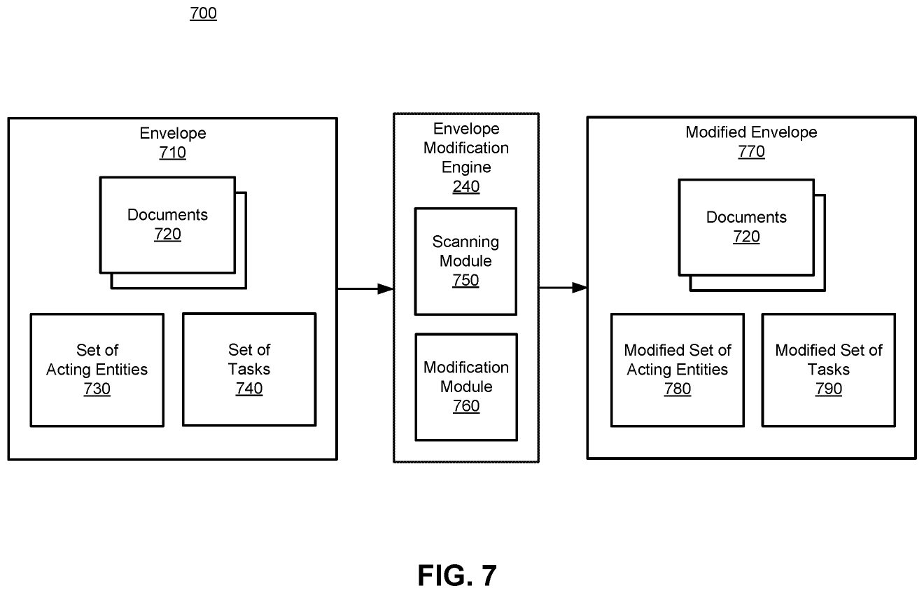

FIG. 7 illustrates a data flow diagram 700 for the second process of managing modifications to a document package using a centralized document system 110, according to one embodiment. Embodiments of the data flow diagram 700 may include different and/or additional modules.

An envelope 710 (also referred to as a document package) is generated to include one or more documents 720 and to identify a set of acting entities 730 and, for each acting entity in the set of acting entities 730, a set of tasks 740 that are to be performed by the acting entity. The envelope 710 may be generated at the request of an originating entity 140 at organization 135A. The documents 720 may be of one or more document types. For example, the envelope 710 may include one document 720 of a sales contract document type. The set of acting entities 730 may include one or more receiving entities 150 of organization 135B identified by originating entity 140 to receive the envelope 710. The set of tasks 740 may include to review the one or more documents 720, initial the one or more documents 720, and/or sign the one or more documents 720.

As described above, the envelope modification engine 240 may scan and modify the envelope 710. A scanning module 750 of the envelope modification engine 240 may access a policy of organization 135B. The policy may identify, for each of one or more document types, a second set of acting entities corresponding to the document type. Further, for each acting entity of the second set of acting entities, the policy may identify a second set of tasks that the acting entity is to perform before the one or more documents 720 can be executed. For example, the policy may identify two receiving entities 150 for a bank form (a document type) and two receiving entities 150 for a sales contract (another document type). The scanning module 750 scans the envelope 710 to determine if the envelope 710 includes at least one document 720 of the one or more document types identified by the policy. In the same example, the scanning module 750 determines the envelope 710 includes a sales contract.

A modification module 760 of the envelope modification engine 240 may modify the envelope 710 in response to the envelope 710 including at least one document of the one or more document types identified by the policy. The modification module 760 may modify the set of acting entities 730 to include one or more acting entities of the second set of acting entities corresponding to the at least one document type without requesting permission from the originating entity 140. For, the modification module 760 modifies the set of acting entities 730 to include the two receiving entities 150 identified in the policy as the second set of acting entities for a document 720 of the identified document type (a sales contract).

A modified envelope 770 is produced by the envelope modification engine 240 and provided to a modified set of acting entities 780. In the same example, the modified set of acting entities 780 may include the set of acting entities 730 and the two receiving entities in the second set of acting entities. The modified envelope 770 may also identify a modified set of tasks 790 for the modified set of acting entities 780 to perform prior to execution of the one or more documents 720.

### Document Package Modification Based on Entity Unavailability

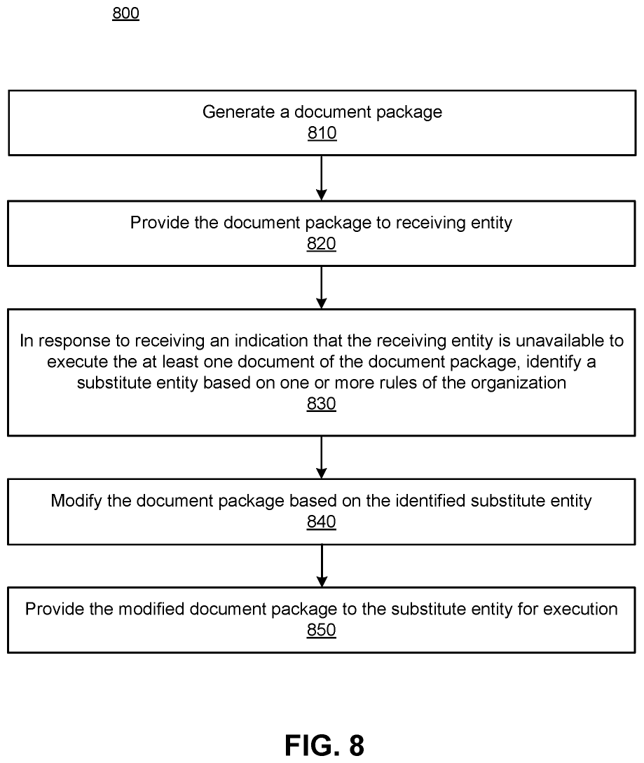

FIG. 8 is a flowchart illustrating a third process 800 for managing modifications to a document package using a centralized document system 110, according to one embodiment. It should be noted that in other embodiments, the third process 800 illustrated in FIG. 8 can include fewer, additional, or different steps that those described herein.

The centralized document system 110 generates 810 a document package. The document package includes at least one document for execution by a receiving entity 150. The centralized document system 110 may generate the document package in response to a request from an originating entity 140.

The centralized document system 110 provides 820 the document package to the receiving entity 150. For example, the centralized document system 110 may send the document package to the receiving entity 150 via email. In another example, the centralized document system 110 may provide the document package to a user account associated with the receiving entity 150.

In response to receiving an indication that the receiving entity 150 is unavailable to execute the at least one document of the document package, the centralized document system 110 identifies 830 a substitute entity based on one or more rules of the organization 135B. For example, the centralized document system 110 may receive an out of office message from the email account associated with the receiving entity 150. In another example, the centralized document system 110 may receiving a message from an organization 135B of the receiving entity 150. The message may indicate that the receiving entity 150 is unavailable. In some embodiments, the centralized document system 110 may identify the substitute entity by querying an org chart of the organization 135B. The centralized document system 110 may identify the substitute entity by identify an entity of organization 135B with a title, role, and/or department that meets or exceeds a threshold title, threshold role, and/or threshold department.

The centralized document system 110 modifies 840 the document package based on the identified substitute entity. For example, the centralized document system 110 may change recipient information associated with the document package to include recipient information (e.g., contact information) for the identified substitute entity.

The centralized document system 110 provides 850 the modified document package to the substitute entity for execution. For example, the centralized document system 110 may provide the modified document package to the substitute entity via email and/or via a user account associated with the substitute entity.

### ADDITIONAL CONSIDERATIONS

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

1. A method comprising:
generating, by a centralized document system, in response to a request from an originating entity, a document package to provide to an organization, the document package including at least one document for execution, the document package identifying a first set of acting entities within the organization, and, for each acting entity of the first set of acting entities, the document package identifying a first set of tasks that the acting entity is to perform with regards to the document package, the first set of tasks comprising a plurality of different tasks;
accessing, by the centralized document system, a policy of the organization that identifies, for each of one or more document types, a second set of acting entities corresponding to the document type and, for each acting entity of the second set of acting entities, identifying a second set of tasks other than execution that the acting entity is to perform before the at least one document can be executed;
scanning, by the centralized document system, the document package to determine whether the document package includes at least one document of the one or more document types identified by the policy;
in response to the document package including at least one document of the one or more document types identified by the policy, automatically modifying, by the centralized document system, the first set of acting entities to include one or more acting entities of the second set of acting entities corresponding to the at least one document type without requesting permission from the originating entity; and
providing, by the centralized document system, the document package to the organization for performance of the tasks.

2. The method of claim 1, wherein the document types include: a purchase agreement, a confidentiality agreement, a rental agreement, an employee agreement, a sales contract, and a bank form.

3. The method of claim 1, wherein the policy of the organization identifies a third set of acting entities corresponding to one or more types of document contents identified by the policy and, for each acting entity of the third set of acting entities, identifying a third set of tasks that the acting entity is to perform before the at least one document can be executed, and the method further comprising:
scanning, by the centralized document system, the at least one document of the document package to determine whether the at least one document includes one or more of the types of document contents identified by the policy; and
in response to the at least one document including one or more of the types of document contents identified by the policy, automatically modifying, by the centralized document system, the first set of acting entities to include one or more acting entities of the third set of acting entities corresponding to the one or more types of document contents without requesting permission from the originating entity.

4. The method of claim 3, wherein scanning the at least one document of the document package to determine whether the at least one document includes one or more of the types of document contents identified by the policy comprises:
identifying, by the centralized document system, text of the at least one document; and
performing, by the centralized document system, natural language processing on the identified text to identify the one or more types of document contents.

5. The method of claim 3, wherein the one or more types of document contents includes one or more of: a payment amount, a payment term, a late payment penalty, a limited liability clause, and a product or service.

6. The method of claim 3, wherein the one or more types of document contents include a payment amount, wherein the policy of the organization identifies a payment threshold, and wherein the first set of acting entities is modified to include one or more acting entities of the third set of acting entities in response to the payment amount exceeding the payment threshold.

7. The method of claim 1, wherein any of the first set of tasks or the second set of tasks includes one or more of: reviewing the at least one document, initialing the at least one document, and signing the at least one document.

8. A non-transitory computer-readable storage medium storing executable instructions that, when executed by a hardware processor, cause the processor to perform steps comprising:
generating, by a centralized document system, in response to a request from an originating entity, a document package to provide to an organization, the document package including at least one document for execution, the document package identifying a first set of acting entities within the organization, and, for each acting entity of the first set of acting entities, the document package identifying a first set of tasks that the acting entity is to perform with regards to the document package, the first set of tasks comprising a plurality of different tasks;
accessing, by the centralized document system, a policy of the organization that identifies, for each of one or more document types, a second set of acting entities corresponding to the document type and, for each acting entity of the second set of acting entities, identifying a second set of tasks other than execution that the acting entity is to perform before the at least one document can be executed;
scanning, by the centralized document system, the document package to determine whether the document package includes at least one document of the one or more document types identified by the policy;
in response to the document package including at least one document of the one or more document types identified by the policy, automatically modifying, by the centralized document system, the first set of acting entities to include one or more acting entities of the second set of acting entities corresponding to the at least one document type without requesting permission from the originating entity; and
providing, by the centralized document system, the document package to the organization for performance of the tasks.

9. The non-transitory computer-readable storage medium of claim 8, wherein the document types include: a purchase agreement, a confidentiality agreement, a rental agreement, an employee agreement, a sales contract, and a bank form.

10. The non-transitory computer-readable storage medium of claim 8, wherein the policy of the organization identifies a third set of acting entities corresponding to one or more types of document contents identified by the policy and, for each acting entity of the third set of acting entities, identifying a third set of tasks that the acting entity is to perform before the at least one document can be executed, and wherein the instructions further cause the processor to perform steps comprising:
scanning, by the centralized document system, the at least one document of the document package to determine whether the at least one document includes one or more of the types of document contents identified by the policy; and
in response to the at least one document including one or more of the types of document contents identified by the policy, automatically modifying, by the centralized document system, the first set of acting entities to include one or more acting entities of the third set of acting entities corresponding to the one or more types of document contents without requesting permission from the originating entity.

11. The non-transitory computer-readable storage medium of claim 10, wherein scanning the at least one document of the document package to determine whether the at least one document includes one or more of the types of document contents identified by the policy comprises:
identifying, by the centralized document system, text of the at least one document; and
performing, by the centralized document system, natural language processing on the identified text to identify the one or more types of document contents.

12. The non-transitory computer readable storage medium of claim 10, wherein the one or more types of document contents includes one or more of: a payment amount, a payment term, a late payment penalty, a limited liability clause, and a product or service.

13. The non-transitory computer readable storage medium of claim 10, wherein the one or more types of document contents include a payment amount, wherein the policy of the organization identifies a payment threshold, and wherein the first set of acting entities is modified to include one or more acting entities of the third set of acting entities in response to the payment amount exceeding the payment threshold.

14. The non-transitory computer readable storage medium of claim 8, wherein any of the first set of tasks or the second set of tasks includes one or more of: reviewing the at least one document, initialing the at least one document, and signing the at least one document.

15. A centralized document system comprising a hardware processor and a non-transitory computer-readable storage medium storing instructions that, when executed by the hardware processor, cause the centralized document system to perform steps comprising:
generating, in response to a request from an originating entity, a document package to provide to an organization, the document package including at least one document for execution, the document package identifying a first set of acting entities within the organization, and, for each acting entity of the first set of acting entities, the document package identifying a first set of tasks that the acting entity is to perform with regards to the document package, the first set of tasks comprising a plurality of different tasks;
accessing a policy of the organization that identifies, for each of one or more document types, a second set of acting entities corresponding to the document type and, for each acting entity of the second set of acting entities, identifying a second set of tasks other than execution that the acting entity is to perform before the at least one document can be executed;
scanning the document package to determine whether the document package includes at least one document of the one or more document types identified by the policy;
in response to the document package including at least one document of the one or more document types identified by the policy, automatically modifying the first set of acting entities to include one or more acting entities of the second set of acting entities corresponding to the at least one document type without requesting permission from the originating entity; and
providing the document package to the organization for performance of the tasks.

16. The centralized document system of claim 15, wherein the document types include: a purchase agreement, a confidentiality agreement, a rental agreement, an employee agreement, a sales contract, and a bank form.

17. The centralized document system of claim 15, wherein the policy of the organization identifies a third set of acting entities corresponding to one or more types of document contents identified by the policy and, for each acting entity of the third set of acting entities, identifying a third set of tasks that the acting entity is to perform before the at least one document can be executed, and wherein the instructions further cause the centralized document system to perform steps comprising:
scanning the at least one document of the document package to determine whether the at least one document includes one or more of the types of document contents identified by the policy; and
in response to the at least one document including one or more of the types of document contents identified by the policy, automatically modifying the first set of acting entities to include one or more acting entities of the third set of acting entities corresponding to the one or more types of document contents without requesting permission from the originating entity.

18. The centralized document system of claim 17, wherein scanning the at least one document of the document package to determine whether the at least one document includes one or more of the types of document contents identified by the policy comprises:
identifying text of the at least one document; and
performing natural language processing on the identified text to identify the one or more types of document contents.

19. The centralized document system of claim 17, wherein the one or more types of document contents includes one or more of: a payment amount, a payment term, a late payment penalty, a limited liability clause, and a product or service.

20. The centralized document system of claim 17, wherein the one or more types of document contents include a payment amount, wherein the policy of the organization identifies a payment threshold, and wherein the first set of acting entities is modified to include one or more acting entities of the third set of acting entities in response to the payment amount exceeding the payment threshold.
